(19) United States
(12) Patent Application Publication
(10) Pub. No.: US 2014/0328478 A1
(43) Pub. Date: Nov. 6, 2014

(54) METHOD AND SYSTEM FOR IDENTIFYING PRANK CALL, CLIENT, SERVER, AND STORAGE MEDIUM

(71) Applicant: TENCENT TECHNOLOGY (SHENZHEN) COMPANY LIMITED, Shenzhen (CN)

(72) Inventors: Yu CHEN, Shenzhen (CN); Jing HE, JR., Shenzhen (CN); Bin LI, Shenzhen (CN)

(21) Appl. No.: 14/333,733

(22) Filed: Jul. 17, 2014

Related U.S. Application Data
(63) Continuation of application No. PCT/CN2013/090924, filed on Dec. 30, 2013.

(30) Foreign Application Priority Data
Apr. 17, 2013 (CN) 201310133243.8

(51) Int. Cl. H04M 3/436

(52) U.S. Cl. CPC H04M 3/436
USPC 379/142.06

(57) ABSTRACT

A method and a system for identifying a prank call, a client, a server, and a storage medium, and the method includes: sending a questionable telephone number to a server through a network instant message by a client; receiving a query result on the questionable telephone number from the server; adding the questionable telephone number to a contact blacklist when the query result shows that the questionable telephone number is a malicious telephone number; and identifying whether an incoming call from the questionable telephone number is a prank call according to the contact blacklist when an incoming call from the questionable telephone number is received. The present disclosure allows for effective identification of prank calls.

### CROSS-REFERENCE TO RELATED APPLICATIONS

This patent application claims priority to and is a continuation application of PCT/CN2013/090924, filed on Dec. 30, 2013 and entitled “METHOD AND SYSTEM FOR IDENTIFYING PRANK CALL, CLIENT, SERVER, AND STORAGE MEDIUM”, which claims priority to a Chinese Patent Application No. 201310133243.8, filed on Apr. 17, 2013 by Tencent Technology (Shenzhen) Co., Ltd. and entitled “Method and System for Identifying Prank Call, Client, and Server”, the disclosures of which are incorporated herein by reference in their entirety.

### FIELD OF THE INVENTION

The present disclosure relates to the field of instant messaging technologies, in particular to a method and a system for identifying a prank call, a client, a server, and a storage medium.

### BACKGROUND OF THE INVENTION

With the application and popularization of mobile terminals, prank calls (also known as a crank call) for purposes such as fraud and insurance selling have become a serious problem troubling the daily life of users of the mobile terminals. Although most mobile terminals can identify or intercept prank calls through blacklists, prank calls cannot be identified and intercepted in the mobile terminals based on non-jailbreak iPhone platforms, because the number information of an incoming call cannot be accessed due to the limitation on system privileges in the iPhone platforms.

### SUMMARY OF THE INVENTION

Embodiments of the present disclosure provide a method and a system for identifying a prank call, a client, a server, and a storage medium, aiming to solve a problem that a prank call cannot be identified in a mobile terminal based on the existing iPhone platform.

In a first aspect, an embodiment of the present disclosure provides a method for identifying a prank call, including:

sending a questionable telephone number to a server through a network instant message by a client;

receiving a query result on the questionable telephone number from the server, and adding the questionable telephone number to a contact blacklist when the query result shows that the questionable telephone number is a malicious telephone number; and

identifying whether the incoming call is a prank call according to the contact blacklist when an incoming call from the questionable telephone number is received.

In a second aspect, an embodiment of the present disclosure provides a method for identifying a prank call, including:

receiving, by a server, a questionable telephone number sent by a client;

querying whether the questionable telephone number is a malicious telephone number in a cloud malicious-telephone-number library so as to obtain a query result; and

sending the query result to the client through the network instant message.

In a third aspect, an embodiment of the present disclosure provides a client, including:

a telephone number sending unit, configured for sending a questionable telephone number to a server through a network instant message;

a telephone number adding unit, configured for receiving a query result on the questionable telephone number from the server, and adding the questionable telephone number to a contact blacklist when the query result shows that the questionable telephone number is a malicious telephone number; and

a telephone number identifying unit, configured for identifying whether the incoming call is a prank call according to the contact blacklist when an incoming call from the questionable telephone number is received.

In a fourth aspect, an embodiment of the present disclosure provides a server, including:

a telephone number receiving unit, configured for receiving a questionable telephone number sent by a client;

a telephone number querying unit, configured for querying whether the questionable telephone number is a malicious telephone number in a cloud malicious-telephone-number library so as to obtain a query result; and

a result sending unit, configured for sending the query result to the client through the network instant message.

In a fifth aspect, an embodiment of the present disclosure provides a system for identifying a prank call, including a client and a server, where

the client is configured for: sending a questionable telephone number to the server through a network instant message; receiving a query result on the questionable telephone number from the server; adding the questionable telephone number to a contact blacklist when the query result shows that the questionable telephone number is a malicious telephone number; and identifying whether an incoming call from the questionable telephone number is a prank call according to the contact blacklist when the incoming call is received; and

the server is configured for: receiving the questionable telephone number sent by the client; querying whether the questionable telephone number is a malicious telephone number in a cloud malicious-telephone-number library so as to obtain the query result; and sending the query result to the client through the network instant message.

In a sixth aspect, an embodiment of the present disclosure provides a non-transitory storage medium containing computer-executable instructions, wherein the computer-executable instructions, when are executed by a computer processor, are configured for performing a method for identifying a prank call, wherein the method for identifying a prank call includes:

sending a questionable telephone number to a server through a network instant message by a client;

receiving a query result on the questionable telephone number from the server, and adding the questionable telephone number to a contact blacklist when the query result shows that the questionable telephone number is a malicious telephone number; and

identifying whether the incoming call is a prank call according to the contact blacklist when an incoming call from the questionable telephone number is received.

According to the method and the system for identifying a prank call, the client, the server, and the storage medium disclosed by the embodiments of the present disclosure, through querying a malicious telephone number at the server and identifying whether an incoming call is a prank call according to a query result, the problem that a prank call cannot be identified by a mobile terminal based on the existing iPhone platform is solved, thereby effectively identifying a prank call.

### BRIEF DESCRIPTION OF DRAWINGS

FIG. 1 is a flowchart of a method for identifying a prank call provided in a first embodiment of the present disclosure;

FIG. 2 is a schematic diagram of querying a telephone number in a server by a client in the method for identifying a prank call provided in the first embodiment of the present disclosure;

FIG. 3 is a contact blacklist established by a client in the method for identifying a prank call provided in the first embodiment of the present disclosure;

FIG. 4 is a schematic diagram showing the effect of identifying a questionable incoming call at a client in the method for identifying a prank call provided in the first embodiment of the present disclosure;

FIG. 5 is a schematic diagram of enabling the function of automatic questionable-number updating in the method for identifying a prank call provided in a second embodiment of the present disclosure;

FIG. 6 is a flowchart of a method for identifying a prank call provided in a third embodiment of the present disclosure; and

FIG. 7 is a diagram showing the specific structure of a system for identifying a prank call provided in a fourth embodiment of the present disclosure.

### DESCRIPTION OF EMBODIMENTS

To make the objectives, technical solutions and advantages of the present disclosure more apparent, the present disclosure is further described in detail with reference to the accompanying drawings and embodiments. It should be understand that the embodiments described herein are merely intended for illustrating the present disclosure rather than limiting the present disclosure.

In an embodiment of the present disclosure, a client sends a questionable telephone number to a server through a network instant message; the client receives a query result on the questionable telephone number from the server, and adds the questionable telephone number to a contact blacklist when the query result shows that the questionable telephone number is a malicious telephone number; and when receiving an incoming call from the questionable telephone number, the client identifies whether the incoming call is a prank call according to the contact blacklist.

The implementation of the present disclosure is described in detail with reference to embodiments below.

### First Embodiment

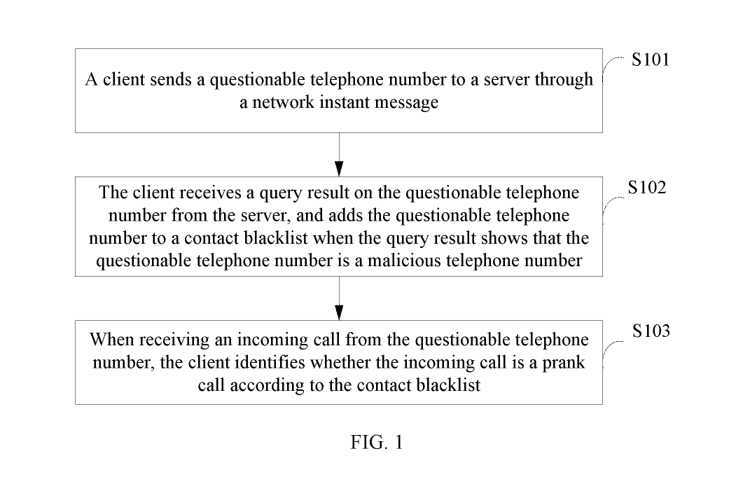

FIG. 1 shows a flowchart of a method for identifying a prank call provided in a first embodiment of the present disclosure, which includes steps S101-S103 and is described in detail as follows.

It should be noted that a client in this and the following embodiments may be a mobile terminal based on any platform, and particularly may be a mobile terminal based on the iPhone platform.

At step S101, a client sends a questionable telephone number to a server through a network instant message.

In this embodiment, the network instant message is a real-time message transferred between a client and a server over a network, and carries a client identifier, so that the server feeds back a query result to the client according to the client identifier. The questionable telephone number is a telephone number, a call from which is considered by a user as a possible prank call, and comes from telephone numbers inputted by the user and received by a corresponding control. The client sends the questionable telephone number to the server through the network instant message.

At step S102, the client receives a query result on the questionable telephone number from the server, and adds the questionable telephone number to a contact blacklist when the query result shows that the questionable telephone number is a malicious telephone number.

In this embodiment, the contact blacklist is used for storing prank call numbers to be reminded and corresponding harassment types thereof, including but not limited to a contact list at the client. The malicious telephone numbers include telephone numbers for purposes such as fraud and insurance selling, which are collected by the server and unwanted to answer by users. The cloud malicious-telephone-number library is configured for storing information such as malicious telephone numbers collected by the server, harassment types and home locations thereof, and the number of tip-offs thereon made by a client. The cloud malicious-telephone-number library can be arranged on the server or other independent cloud server. The query result includes, but not limited to, that whether the questionable telephone number is a malicious telephone number and the harassment type of the questionable telephone number, where the harassment type is determined according to the purpose of an incoming call, including but not limited to fraud, harassment, and advertising promotion. The client receives the query result on the questionable telephone number from the server, and adds the questionable telephone number to the contact blacklist if the query result shows that the questionable telephone number is a malicious telephone number.

At step S103, when receiving an incoming call from the questionable telephone number, the client identifies whether the incoming call is a prank call according to the contact blacklist.

In this embodiment, when receiving an incoming call from the questionable telephone number, the client identifies whether the incoming call is a prank call according to the contact blacklist specifically by, when the incoming call is made from a questionable telephone number in the contact blacklist, identifying the incoming call as a prank call.

Specifically, if the query result shows that the questionable telephone number is a malicious telephone number, the client adds the questionable telephone number to the contact blacklist, and reminds the user that the questionable telephone number is a malicious telephone number by means of an annotation on the harassment type, an audio notification, and the like. If the query result shows that the questionable telephone number is not a malicious telephone number and is not present in the contact blacklist, the client does not remind the user about the questionable telephone number.

Optionally, after step S103, when the incoming call is identified as a prank call according to the contact blacklist, the client also reminds the user about the harassment type of the incoming call.

Specifically, if the incoming call is identified as a prank call, the client reminds the user about the harassment type of the incoming call by means of a label, an audio notification, or other means easily attracting the attention of the user.

Further optionally, the client receives at least one malicious telephone number and the corresponding harassment type thereof sent by the server, and respectively adds the malicious telephone number to the contact blacklist.

Specifically, when the client enables the function of adding blacklist automatically, according to the at least one malicious telephone number and the corresponding harassment type thereof sent by the server, the malicious telephone number is automatically added to the contact blacklist.

The scene applicable to the present embodiment is described below in an example where a Q instant messenger client is taken as a specific target object.

It should be noted that the Q instant messenger provides a function of receiving and sending messages in real time through a network, and supports pictures, audios, texts, handwriting, and the like. When a contact object as listed in a contact list on the Q instant messenger client is using the Q instant messenger, it is possible to conduct an instant chat with the contact object through the Q instant messenger, which is both convenient and economical. A Q instant messenger server carries out instant messaging interaction with the Q instant messenger client through a Q instant messaging channel.

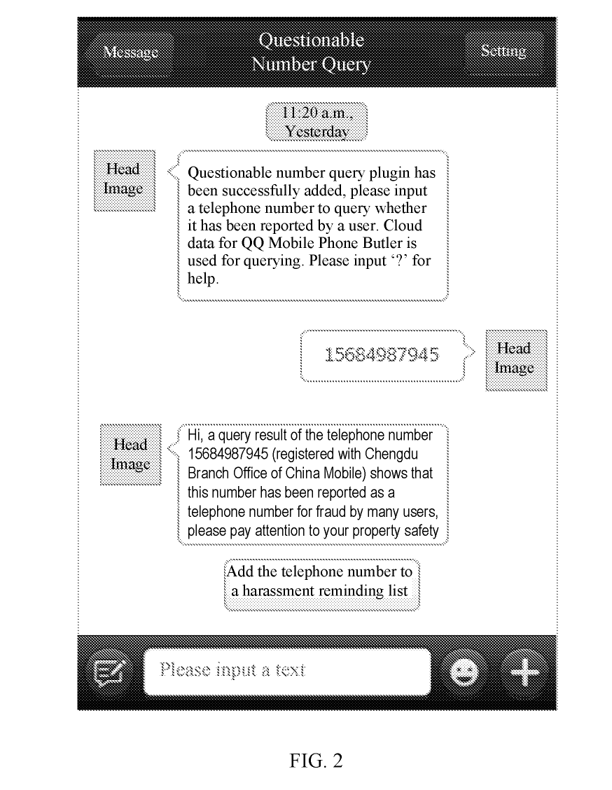

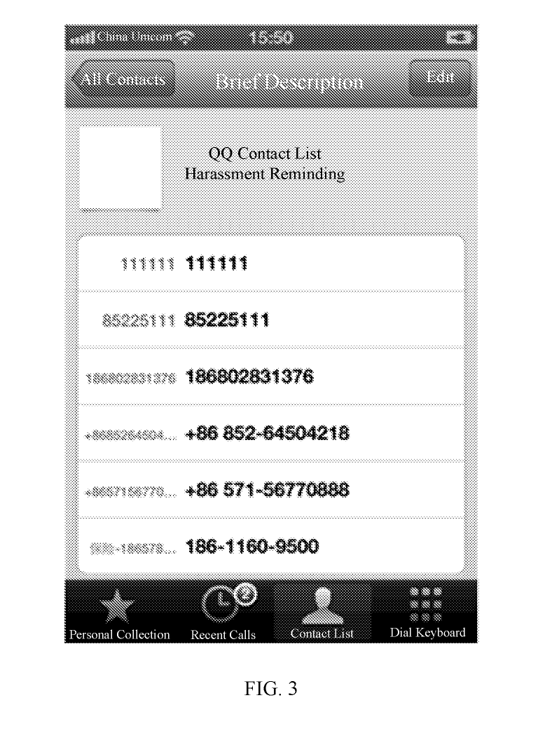

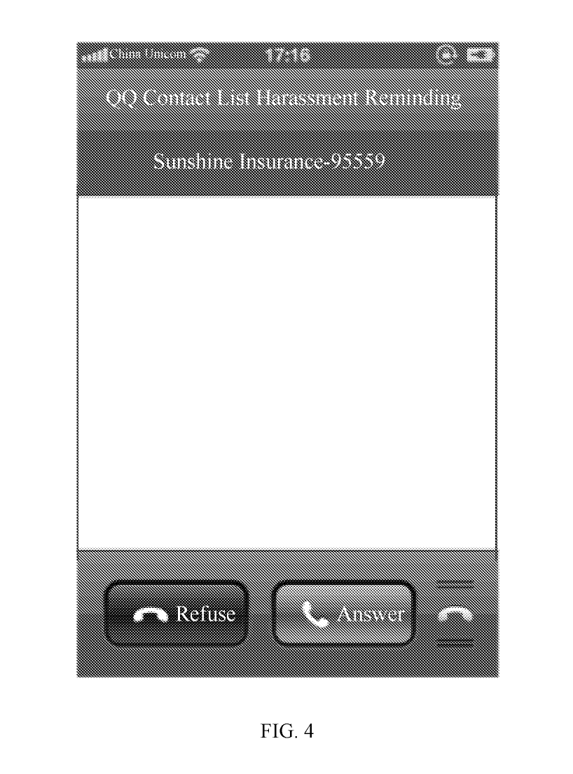

As shown in FIG. 2, a user inputs a questionable telephone number to a telephone number inquiry plugin of the Q instant messenger client; the Q instant messenger server receives the questionable telephone number from the client through a Q instant message and queries the questionable telephone number in its malicious-telephone-number library so as to obtain a query result, which includes that whether the questionable telephone number is a malicious telephone number and the corresponding harassment type of the questionable telephone number; the Q instant messenger server returns the query result to the Q instant messenger client by means of the Q instant message; the Q instant messenger client adds the questionable telephone number to the contact blacklist according to the query result and marks the questionable telephone number as a malicious telephone number according to the harassment type, specifically, by means of creating a contact object in the contact blacklist and recording the malicious telephone number and the harassment type thereof in the contact object. The contact blacklist is shown in FIG. 3. When a call comes, the client marks the questionable telephone number through a contact category label corresponding to the harassment type, and shows the label to the user, so that the client can effectively identify the incoming call and remind the user that the questionable telephone number is a malicious telephone number, as shown in FIG. 4.

In this embodiment, a questionable telephone number is sent to the server through the instant message channel so as to query whether the questionable telephone number is a malicious telephone number, and it is determined whether to identify the incoming call is a prank call according to the query result from the server, thereby effectively identifying the prank call at the client.

### Second Embodiment

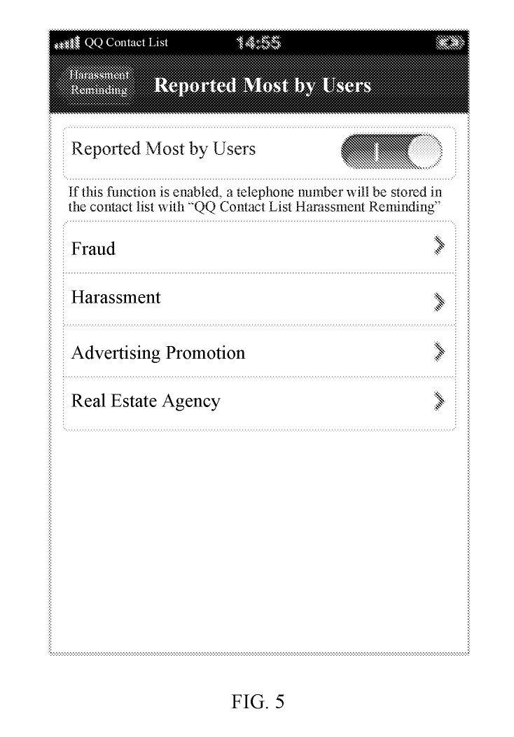

FIG. 5 shows another scene applicable to a method for identifying a prank call provided in a second embodiment of the present disclosure, and this scene is described in detail as follows.

At the Q instant messenger client, if a user enables the function of adding a telephone number receiving most tip-offs from users (i.e. reported most by users) to a contact blacklist, as shown in FIG. 5, the Q instant messenger client regularly receives a plurality of malicious telephone numbers which are sent from the Q instant messenger server and rank high in the cloud malicious-telephone-number library in terms of received tip-offs, and respectively adds the plurality of malicious telephone numbers to a contact blacklist. When a call comes from the questionable telephone number, the Q instant messenger client identifies the incoming call according to the contact blacklist; and if the questionable telephone number is already stored in the contact blacklist, the incoming call is identified as a prank call, and the Q instant messenger client reminds the user according to the harassment type as shown in FIG. 4.

### Third Embodiment

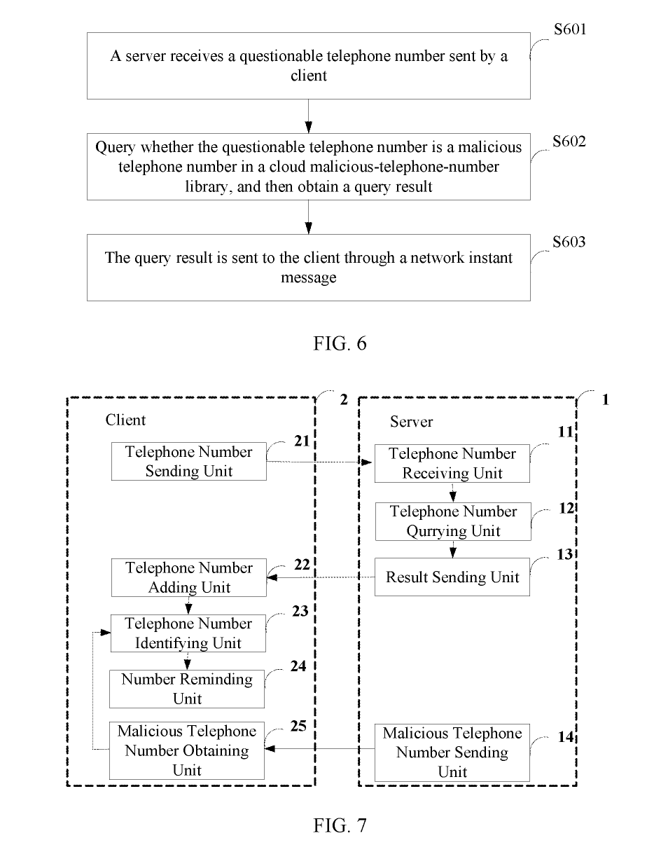

FIG. 6 shows a flowchart of a method for identifying a prank call provided in a third embodiment of the present disclosure, and the method includes steps S601-S603 and is described in detail as follows.

At step S601, a server receives a questionable telephone number sent by a client.

In this embodiment, the server receives the questionable telephone number sent by the client through an instant message.

At step S602, it is queried whether the questionable telephone number is a malicious telephone number in a cloud malicious-telephone-number library, and then a query result is obtained.

In this embodiment, the malicious telephone numbers include telephone numbers for purposes such as fraud and insurance selling, which are collected by the server and unwanted to answer by users. The cloud malicious-telephone-number library is configured for storing information such as malicious telephone numbers collected by the server, harassment types and home locations thereof, and the number of tip-offs thereon made by a client. The cloud malicious-telephone-number library can be arranged on the server or other independent cloud server. The query result includes, but not limited to, that whether the questionable telephone number is a malicious telephone number and the harassment type of the questionable telephone number, where the harassment type is determined according to the purpose of an incoming call, including but not limited to fraud, harassment, and advertising promotion. A query result is obtained by querying that whether the questionable telephone number is a malicious telephone number in a cloud malicious-telephone-number library.

At step S603, the query result is sent to the client through a network instant message.

In this embodiment, the query result includes that whether the questionable telephone number is a malicious telephone number and the corresponding harassment type of the questionable telephone number. The server sends the query result to the client through the network instant message.

Optionally, the server can further send at least one malicious telephone number and the corresponding harassment type thereof in the cloud malicious-telephone-number library to the client through the network instant message.

Specifically, the server collects malicious telephone numbers sent by various clients so as to establish the cloud malicious-telephone-number library. When the function of adding blacklist automatically is enabled at the client, the server may send at least one malicious telephone number and the corresponding harassment type thereof in the cloud malicious-telephone-number library to the client through the network instant message, to enable the client to automatically update the contact blacklist. Here, the at least one malicious telephone number is the malicious telephone number which ranks high in terms of received tip-offs in the cloud malicious-telephone-number library.

In an example where a Q instant messenger server is taken as a specific target object, a scene applicable to this embodiment is described below.

The Q instant messenger server collects telephone numbers for purposes such as fraud and insurance selling which are unwanted to answer by a user so as to establish the cloud malicious-telephone-number library, and updates the data of the cloud malicious-telephone-number library in real time according to tip-offs from users. When a certain Q instant messenger client sends a questionable telephone number to the Q instant messenger server through a Q instant message, the Q instant messenger server queries the received questionable telephone number in the cloud malicious-telephone-number library so as to determine whether the questionable telephone number is a malicious telephone number and the harassment type thereof, thereby obtaining a query result which includes that whether the questionable telephone number is a malicious telephone number and the corresponding harassment type of the questionable telephone number; the Q instant messenger server returns the query result to the Q instant messenger client through the Q instant message, so that the Q instant messenger client identifies the questionable telephone number according to the query result. Optionally, when the Q instant messenger client enables the function of adding a telephone number receiving most tip-offs from users to the contact blacklist, the server regularly sends a plurality of malicious telephone numbers ranking high in the cloud malicious-telephone-number library in terms of received tip-offs to the Q instant messenger client, so as to automatically synchronize the questionable telephone numbers in the contact blacklist of the Q instant messenger client.

In this embodiment, it is achieved that a cranks call can be effectively identified by the client according to the query result by means of querying whether the questionable telephone number sent by the client is a malicious telephone number in the cloud malicious-telephone-number library, and sending a query result to the client.

### Fourth Embodiment

FIG. 7 shows a specific diagram showing the structure of a system for identifying a prank call provided in a fourth embodiment of the present disclosure. For the sake of description, only parts relevant to the embodiment of the present disclosure are shown in FIG. 7. In this embodiment, the system for identifying a prank call includes a server 1 and a client 2.

The client 2 is configured for sending a questionable telephone number to the server 1 through a network instant message; receiving a query result on the questionable telephone number from the server, and adding the questionable telephone number to a contact blacklist when the query result shows that the questionable telephone number is a malicious telephone number; and identifying whether the incoming call is a prank call according to the contact blacklist when receiving an incoming call from the questionable telephone number; and

The server 1 is configured for receiving the questionable telephone number sent by the client 2; querying whether the questionable telephone number is a malicious telephone number in a cloud malicious-telephone-number library so as to obtain a query result; and sending the query result to the client 2 through the network instant message.

Further, the client 2 is specifically configured for identifying an incoming call as a prank call when the incoming call is made from a questionable telephone number in the contact blacklist.

The query result includes that whether the questionable telephone number is a malicious telephone number and the corresponding harassment type of the questionable telephone number.

Further, the client 2 is configured for reminding a user about the harassment type of the incoming call when the incoming call is identified as a prank call according to the contact blacklist.

Further, the server 1 is configured for sending at least one malicious telephone number and the corresponding harassment type of the malicious telephone number in the cloud malicious-telephone-number library to the client 2 through the network instant message.

The client 2 is further configured for receiving the at least one malicious telephone number and the corresponding harassment type thereof sent by the server 1, and adding the malicious telephone number to the contact blacklist.

### Fifth Embodiment

Reference may be made to the client 2 in FIG. 7 for details of the structure of a client provided in a fifth embodiment of the present disclosure. For the sake of description, only parts relevant to the present embodiment of the invention are shown. In this embodiment, the client 2 includes a telephone number sending unit 21, a telephone number adding unit 22, a telephone number identifying unit 23, a harassment reminding unit 24 and a malicious telephone number obtaining unit 25.

The telephone number sending unit 21 is configured for sending a questionable telephone number to a server through a network instant message.

The telephone number adding unit 22 is configured for receiving a query result obtained by the server according to the questionable telephone number sent by the telephone number sending unit 21, and adding the questionable telephone number to a contact blacklist when the query result shows that the questionable telephone number is a malicious telephone number.

The telephone number identifying unit 23 is configured for identifying whether the incoming call is a prank call according to the contact blacklist when an incoming call from the questionable telephone number is received. For example, when a mobile terminal with the client 2 described in this embodiment receives an incoming call from the questionable telephone number, the telephone number identifying unit 23 identifies whether the incoming call is a prank call according to the contact blacklist.

Further, the telephone number identifying unit 23 is specifically configured for identifying the incoming call as a prank call when the incoming call is made from a questionable telephone number in the contact blacklist.

Further, the client 2 includes:

a harassment reminding unit 24 configured for reminding a user about the harassment type of the incoming call when the telephone number identifying unit 23 identifies the incoming call as a prank call according to the contact blacklist.

Further, the client 2 includes:

a malicious telephone number obtaining unit 25 configured for receiving at least one malicious telephone number and the corresponding harassment type of the malicious telephone number sent by the server, and adding the malicious telephone number to the contact blacklist.

The client provided in the embodiment of the present disclosure can be applied to the method in the corresponding first embodiment, and reference may be made to the description of the above first embodiment for more details, which are not discussed here.

### Sixth Embodiment

Reference may be made to FIG. 7 for details of a specific structure of a server provided in a sixth embodiment of the present disclosure. For the sake of description, only parts relevant to the present embodiment of the invention are shown. In this embodiment, the server 1 includes a telephone number receiving unit 11, a telephone number querying unit 12 and a result sending unit 13.

The telephone number receiving unit 11 is configured for receiving a questionable telephone number sent by a client.

The telephone number querying unit 12 is configured for querying whether the questionable telephone number received by the telephone number receiving unit 11 is a malicious telephone number in a cloud malicious-telephone-number library so as to obtain a query result.

The result sending unit 13 is configured for sending the query result obtained by the telephone number querying unit 12 to the client through a network instant message.

Further, the query result includes that whether the questionable telephone number is a malicious telephone number and the corresponding harassment type of the questionable telephone number.

Further, the server 1 includes:

a malicious telephone number sending unit 14 configured for sending at least one malicious telephone number and the corresponding harassment type of the malicious telephone number in the cloud malicious-telephone-number library to the client through the network instant message.

The server provided in the present embodiment of the invention can be applied to the method described in the foregoing third embodiment, and reference may be made to the description of the above third embodiment for more details, which are not discussed here.

It should be noted that: in the foregoing system embodiment, as long as the corresponding function can be implemented, the units of the system are divided in accordance with, but not limited to, functional logics; in addition, the specific name of each functional unit is just intended for distinguishing the functional unit from other functional units, rather than limiting the protection scope of the present disclosure.

An embodiment of the present disclosure provides a non-transitory storage medium containing computer-executable instructions which, when executed by a computer processor, are configured for:

sending a questionable telephone number to a server through a network instant message;

receiving a query result on the questionable telephone number from the server, and adding the questionable telephone number to a contact blacklist when the query result shows that the questionable telephone number is a malicious telephone number; and

identifying whether the incoming call is a prank call according to the contact blacklist when an incoming call from the questionable telephone number is received.

Exemplarily, identifying whether the incoming call from the questionable telephone number is a prank call according to the contact blacklist when the incoming call is received specifically includes:

identifying the incoming call as a prank call when the incoming call is made from a questionable telephone number in the contact blacklist.

Exemplarily, after identifying whether an incoming call from the questionable telephone number is a prank call according to the contact blacklist when the incoming call is received, the method further includes:

reminding a user about the harassment type of the incoming call when the incoming call is identified as a prank call according to the contact blacklist.

Exemplarily, the method further includes:

receiving at least one malicious telephone number and the corresponding harassment type of the malicious telephone number sent by the server, and adding the malicious telephone number to the contact blacklist.

In addition, it can be understood by those skilled in the art that all or a part of the steps of the methods in the foregoing embodiments can be performed by relevant hardware instructed by programs, and the programs can be stored in a computer readable storage medium. The foregoing storage medium may be, for example, an Read Only Memory, an Random Access Memory, a magnetic disc, or an optical disc and the like.

The above description only shows some preferred embodiments of the present disclosure have been described above, rather than limiting the present disclosure. Any modification, equivalent replacement, improvement and the like made without departing from the concept and principle of the present disclosure shall fall within the protection scope of the present disclosure.

What is claimed is:

1. A method for identifying a prank call, comprising:
sending a questionable telephone number to a server through a network instant message by a client;
receiving a query result on the questionable telephone number from the server, and adding the questionable telephone number to a contact blacklist when the query result shows that the questionable telephone number is a malicious telephone number; and
identifying whether the incoming call is a prank call according to the contact blacklist when an incoming call from the questionable telephone number is received.

2. The method according to claim 1, wherein when an incoming call from the questionable telephone number is received, identifying whether the incoming call is a prank call according to the contact blacklist comprises:
identifying the incoming call as a prank call by the client when the incoming call is made from a questionable telephone number in the contact blacklist.

3. The method according to claim 1, wherein after identifying whether the incoming call from the questionable telephone number is a prank call according to the contact blacklist when the incoming call is received, the method further comprises:
reminding a user about a harassment type of the incoming call by the client when the incoming call is identified as a prank call according to the contact blacklist.

4. The method according to claim 2, wherein after identifying whether the incoming call from the questionable telephone number is a prank call according to the contact blacklist when the incoming call is received, the method further comprises:
reminding a user about a harassment type of the incoming call by the client when the incoming call is identified as a prank call according to the contact blacklist.

5. The method according to claim 1, further comprising:
receiving, by the client, at least one malicious telephone number and the corresponding harassment type of the malicious telephone number sent by the server, and respectively adding the malicious telephone number to the contact blacklist.

6. The method according to claim 2, further comprising:
receiving, by the client, at least one malicious telephone number and the corresponding harassment type of the malicious telephone number sent by the server, and respectively adding the malicious telephone number to the contact blacklist.

7. A method for identifying a cranks call, comprising:
receiving, by a server, a questionable telephone number sent by a client through a network instant message;
querying whether the questionable telephone number is a malicious telephone number in a cloud malicious-telephone-number library so as to obtain a query result; and
sending the query result to the client through the network instant message.

8. The method according to claim 7, wherein the query result includes that whether the questionable telephone number is a malicious telephone number and the corresponding harassment type of the questionable telephone number.

9. The method according to claim 7, further comprising:
sending, by the server, at least one malicious telephone number in the cloud malicious-telephone-number library and the corresponding harassment type of the malicious telephone number to the client through the network instant message.

10. The method according to claim 8, further comprising:
sending, by the server, at least one malicious telephone number in the cloud malicious-telephone-number library and the corresponding harassment type of the malicious telephone number to the client through the network instant message.

11. A client, comprising:
a telephone number sending unit, configured for sending a questionable telephone number to a server through a network instant message;
a telephone number adding unit, configured for receiving a query result on the questionable telephone number from the server, and adding the questionable telephone number to a contact blacklist when the query result shows that the questionable telephone number is a malicious telephone number; and
a telephone number identifying unit configured for identifying whether the incoming call is a prank call according to the contact blacklist when an incoming call from the questionable telephone number is received.

12. The client according to claim 11, wherein the telephone number identifying unit is configured for identifying the incoming call as a prank call when the incoming call is made from a questionable telephone number in the contact blacklist.

13. The client according to claim 11, further comprising:
a harassment reminding unit configured for reminding a user about the harassment type of the incoming call when the telephone number identifying unit identifies the incoming call as a prank call according to the contact blacklist.

14. The client according to claim 12, further comprising:
a harassment reminding unit configured for reminding a user about the harassment type of the incoming call when the telephone number identifying unit identifies the incoming call as a prank call according to the contact blacklist.

15. The client according to claim 11, further comprising:
a malicious telephone number obtaining unit configured for receiving at least one malicious telephone number and the corresponding harassment type of the malicious telephone number sent by the server, and adding the malicious telephone number to the contact blacklist.

16. The client according to claim 12, further comprising:
a malicious telephone number obtaining unit configured for receiving at least one malicious telephone number and the corresponding harassment type of the malicious telephone number sent by the server, and adding the malicious telephone number to the contact blacklist.
